(19) United States
(12) Patent Application Publication
(10) Pub. No.: US 2009/0258226 A1
(43) Pub. Date: Oct. 15, 2009

(54) PREPARATION OF VERY HIGH MOLECULAR WEIGHT POLYAMIDE FILAMENTS

(75) Inventors: GLENN ALAN SCHWINN, Seaford, DE (US); Gary Raymond West, Seaford, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A R.L., Wilmington, DE (US)

(21) Appl. No.: 12/250,197

(22) Filed: Oct. 13, 2008

Related U.S. Application Data
(60) Provisional application No. 60/980,617, filed on Oct. 17, 2007.

(51) Int. Cl. D02G 3/02; C08G 69/08; D01F 1/02

(52) U.S. Cl. 428/359; 528/332; 264/211

(57) ABSTRACT

Disclosed is the preparation of very high molecular weight polyamide, e.g., nylon, filaments, as indicated by such filaments exhibiting a very high Relative Viscosity (RV) value. Such filaments can be used to prepare polyamide staple fibers which are especially useful for industrial applications such as in papermachine felts. The filament preparation process involves a melt phase polymerization (MPP) procedure, optionally carried out in combination with a solid phase polymerization (SPP) procedure. Both of these procedures serve to increase the molecular weight and hence the RV of the polyamide filaments produced. These procedures are conducted under selected controlled conditions which permit realization of polyamide filaments of about 2 to 100 denier and which have RV values of greater than about 190. Such filaments also exhibit excellent tenacity and tenacity resistance properties.

### CROSS-REFERENCE TO RELATED APPLICATION

This application claims benefit of priority from Provisional Application No. 60/980,617, filed Oct. 17, 2007. This application hereby incorporates by reference Provisional Application No. 60/980,617 in its entirety.

### FIELD OF THE INVENTION

This invention relates to the preparation of very high molecular weight polyamide, e.g., nylon, filaments. Very high molecular weight is indicated by the filaments exhibiting a very high Relative Viscosity (RV) as defined herein. Such filaments can be used to prepare polyamide staple fibers which are especially useful for industrial applications such as in papermachine felts.

### BACKGROUND OF THE INVENTION

Industrial polyamide filaments are used in, among other things, tire cords, airbags, netting, ropes, conveyor belt cloth, felts, filters, fishing lines, and industrial cloth and tarps. When used as staple fibers for papermaking machine felts, the fibers must have generally good resistance to chemicals and generally good wear resistance (e.g., resistance to abrasion, impact and flex fatigue). Such felts are often exposed to oxidizing aqueous solutions which can seriously shorten the service life of the felt.

Stabilizers are often added to polyamides for the purpose of increasing chemical resistance. The amount of stabilizer which can be introduced is limited, however, due to excess foaming that occurs during polymerization when stabilizers are added to autoclaves or continuous polymerizers (CPs).

Another way of improving chemical and abrasion resistance of fibers used in papermaking machine felts is to make fibers from melt spun filaments which have relatively high molecular weight as reflected by such filaments exhibiting high Relative Viscosity (RV). However, in the past, when the polyamide supply for such filaments is polyamide flake, it was often difficult, if not impossible, to obtain filaments of the desired high RV while maintaining polymer quality, e.g., low level of cross linking and/or branching.

One way to increase the RV of polyamide filaments is to increase the amount of catalyst present during polymerization in an autoclave, continuous polymerizer (CP), or elsewhere in the process. This, however, can cause process and/or product problems. Difficulties, for instance, similar to those encountered with stabilizers can occur when catalysts are added in amounts suitable to increase polymer molecular weight. Further, high quantities of catalysts in the autoclave can cause severe injection port pluggage and complications to injection timings during autoclave cycles. High quantities of catalysts injected into CPs place stringent demands on equipment capability because of high levels of water loading.

In U.S. Pat. No. 5,236,652 to Kidder, a process is disclosed for making polyamide fibers for use as staple for papermaking machine felt. This process comprises (i) melt-blending polyamide flake with a polyamide additive concentrate which is made of a polyamide flake and an additive selected from the group of stabilizers, catalysts and mixtures thereof, and (ii) extruding the melt-blended mixture from a spinneret to form the higher RV fibers. The Kidder process thus requires separate preparation of a polyamide additive concentrate which is added to an extruder used in melt-blending polyamide flake.

Another way to increase the RV of polyamide filaments is through solid phase polymerization (SPP) of the polymer after melt spinning. U.S. Pat. No. 5,234,644 to Schutze et al discloses a post spin SPP process for making high RV polyamide fibers for use in paper machinery webs. In this process, in contrast to prior staple fiber manufacturing processes, the post spin SPP process requires an added step after spinning the fibers with special processing equipment to increase the RV of the fibers. This special equipment adds a significant cost to the producer and the added post spinning step takes additional time to make the fibers. Furthermore, uniform fiber property control is more difficult when the post spinning SPP step is performed in a batch mode.

A process and apparatus setup for preparing very high RV polyamide filaments is also disclosed in U.S. Pat. No. 6,235,390 to Schwinn and West. Such a process utilitizes both a solid phase polymerization (SPP) conditioning of polyamide flake materials followed by a melt phase polymerization (MPP) procedure to produce material suitable for spinning into filaments. The SPP phase of such a procedure utilizes a specific type of dual desiccant drying operation to condition catalyst-containing polyamide flake. Such conditioned and dried flake material is then fed to an MPP setup employing a melt-extruder and transfer lines (which optionally run to and through a booster pump and a manifold) to convey molten polyamide material to melt-spinning apparatus. The procedures and apparatus of the Schwinn/West patent permit preparation of filaments having an RV of at least about 140. Preparation of filaments having RV values as high as 169 are, in fact, disclosed in this U.S. Pat. No. 6,235,390.

Prior art methods for obtaining high molecular weight polyamide fibers from high molecular weight polymers present difficulties, and have limitations. Specifically the use of high molecular weight resins, i.e., those of a molecular weight close to the desired fiber molecular weight, creates issues associated with extruding and pumping these polymers because of their high viscosity.

Transporting relatively high viscosity polymers through equipment designed to produce fibers causes increased polymer temperatures due to friction. The amount of temperature increase is directly related to the viscosity (which in turn is related to the molecular weight) of the polymer. The temperature will increase at each step of the filament preparation process, e.g., in the extruder, in transfer lines, in transfer line pumps, in piping manifolds, in spinning meter pumps, and in the spin packs. This is true of conventional, relatively normal molecular weight (RV 50 to 70) polyamide fiber processes. The effect is magnified in processes involving high molecular weight polyamides due to the much higher polymer viscosities involved. The increased polymer temperatures encountered in such processes can result in degradation of the polymer, thereby actually decreasing the molecular weight of the polymer in the resulting filaments.

Given all of the foregoing prior art procedures for preparing and realizing high RV polyamide filaments, and further given the issues associated with preparation of high RV polyamide filaments, it would be advantageous and desirable to identify improved procedures for efficiently producing polyamide, e.g., nylon, filaments having RV values even higher than those which have been previously reported. Such especially high molecular weight filaments would be those having tenacity and abrasion and chemical resistance properties such that they could be used to prepare polyamide staple fibers of especially desirable characteristics for industrial uses, such as, in making papermaking machine felts.

### SUMMARY OF THE INVENTION

In its process aspects, the present invention provides a process for preparing a plurality of meltspun polyamide filaments having a denier of from about 2 to about 100, a formic acid relative viscosity (RV) of greater than about 190, and tenacity and tenacity retention characteristics which render such filaments especially suitable for use in papermaking machine felts. Such a process involves melt phase polymerizing of polyamide flake material before spinning it into filaments. Preferably, the polyamide flake material to be melt phase polymerized has been prepared by a specific solid phase polymerization (SPP) procedure.

In the melt phase polymerization (MPP) part of the process herein, conditioned SPP polyamide flake material having a formic acid relative viscosity (RV) of from about 90 to 120 and a moisture content of less than about 0.04 wt %, preferably prepared as hereinafter described, is used. The MPP procedure comprises the steps of A) feeding these solid phase polymerized (SPP) polyamide flakes at a temperature of from about 120° C. to 200° C. into a non-vented melt-extruder; B) melting the flakes in the melt-extruder while introducing at a flake feed end of the extruder a liquid phenolic antioxidant stabilizer which has not been premixed with polyamide material; C) extruding molten polymer resulting from the melting of said flakes from an outlet end of the melt-extruder to a transfer line wherein the temperature of the molten polymer in the transfer line within 5 feet (2.4 m) of the outlet end of the melt-extruder is from about 285° C. to 295° C.; D) conveying the molten polymer through the transfer line and via a booster pump and a manifold to at least one spinneret of at least one spinning machine; and E) spinning the molten polymer through the at least one spinneret to form a plurality of meltspun high RV polyamide filaments.

In conveying the molten polymer from the melt-extruder to the spinneret, the temperature of polymer in the transfer line within 5 feet (2.4 m) of the at least one spinneret is maintained from about 295° C. to about 300° C. Further, during this transfer of molten polymer from melt-extruder to spinneret, the ratio of a) the pressure drop (ΔP in psig) between the booster pump and the manifold; to b) the molten polymer throughput (in kg/hr) is maintained in the range of from about 2.5 to 3.5.

In a preferred embodiment of the process herein, SPP flake material used in the MPP process has been prepared using a certain type of conditioning procedure. In this SPP conditioning procedure, precursor polyamide flake material is used which comprises a synthetic melt spinnable polyamide polymer and a polyamidation catalyst dispersed within the flakes. Such precursor flake material has a formic acid relative viscosity (RV) of from about 40 to 60. These solid phase polymerized precursor polyamide flakes are preferably conditioned by the steps of: i) feeding the precursor polyamide flakes into a solid phase polymerization vessel; ii) contacting these precursor flakes within this vessel with a substantially oxygen free inert gas; iii) drying at least a portion of the inert gas with a serially connected dual desiccant bed regenerative drying system such that the gas entering the polymerization vessel has a dew point of no more than about 10° C.; iv) heating the inert gas to a temperature of from about 120° C. to 200° C.; v) circulating the filtered, dried, heated gas through interstices between the flakes in the polymerization vessel for 4 to 24 hours; and vi) removing from the vessel, and feeding to the melt phase polymerization part of the process, flakes which have a formic acid relative viscosity (RV) of from about 90 to 120. It is these SPP flakes, conditioned in this manner, which are preferably used as the feed to the melt-extruder in the MPP process herein.

In its composition aspects, the present invention is directed to a plurality of polyamide filaments suitable for use in making fibers for papermaking machine felts. Each of the filaments comprises a synthetic melt spun polyamide polymer and has A) a formic acid relative viscosity of greater than about 190; B) a denier of from about 2 to about 100 (a decitex of about 2.2 to about 111); and C) a tenacity of from about 4.0 grams/denier to about 7.0 grams/denier (from about 3.5 cN/dtex to about 6.2 cN/dtex). Such filaments also exhibit certain retained tenacity characteristics under conditions which simulate those which occur when fibers made from such filaments are used, for example, in papermaking felts.

In preferred embodiments, the polyamide polymer used to form the filaments of this invention is selected from the group consisting of poly(hexamethylene adipamide) [nylon 6,6], poly(ε-caproamide) [nylon 6] and copolymers or mixtures thereof. Also preferably the plurality of filaments will be in the form of staple fibers having a length of about 1.5 to about 5 inches (about 3.8 cm to about 12.7 cm). In other preferred embodiments, the plurality of filaments will be in the form of staple fibers having a saw tooth shaped crimp, with a crimp frequency of about 3.5 to about 18 crimps per inch (about 1.4 to about 7.1 crimps per cm).

### BRIEF DESCRIPTION OF THE DRAWINGS

The invention can be more fully understood from the following detailed description thereof in connection with accompanying drawings briefly described as follows:

FIG. 1 is a schematic illustration of an apparatus for solid phase polymerizing polymer flake.

FIG. 2 is a schematic illustration of a portion of a fiber manufacturing procedure wherein flake is fed to a non vented melt-extruder, melted and extruded to a transfer line, conveyed through the transfer line via a booster pump and manifold to at least one spinneret, spun into filaments, converged into tows, and placed in a storage container.

FIG. 3 is a schematic illustration of a portion of a fiber manufacturing procedure wherein tows are removed from a plurality of storage containers, combined into a tow band, drawn, crimped, and cut to form crimped staple fibers.

Throughout the following detailed description, similar reference characters refer to similar elements in all figures of the drawings.

### DETAILED DESCRIPTION OF THE INVENTION

The present invention is directed to the preparation of industrial, high relative viscosity (RV) polyamide filaments, such as, for use in papermaking machine felts and other staple fiber applications. The invention is further directed to processes which preferably involve both solid phase polymerization (SPP) of polyamide flake and subsequent melt phase polymerization of molten flakes and spinning of the molten polymer into industrial high RV filaments. Accordingly, this invention represents an improvement of the processes and filaments which are disclosed in U.S. Pat. No. 6,235,390, which patent is incorporated herein by reference in its entirety.

For purposes herein, the term “solid phase polymerization” or “SPP” means increasing the RV of polymer while in the solid state. Also, herein increasing polymer RV is considered synonymous with increasing polymer molecular weight. Further, for purposes herein, the term “melt phase polymerization” or “MPP” means increasing the RV (or the molecular weight) of polymer while in the liquid state.

### Industrial High RV Filaments

The invention herein is concerned with the preparation of industrial high RV filaments. For purposes herein, the term “industrial filament” means any filament having a formic acid RV of at least about 70; a denier of at least about 2 (a decitex of about 2.2); and a tenacity of about 4.0 grams/denier to about 11.0 grams/denier (about 3.5 cN/dtex to about 9.7 cN/dtex).

Polymer suitable for use in the process and filaments of this invention consists of synthetic melt spinnable or melt spun polymer. Such polymers can include polyamide homopolymers, copolymers, and mixtures thereof which are predominantly aliphatic, i.e., less than 85% of the amide-linkages of the polymer are attached to two aromatic rings. Widely-used polyamide polymers such as poly(hexamethylene adipamide) which is nylon 6,6 and poly(ε-caproamide) which is nylon 6 and their copolymers and mixtures can be used in accordance with the invention. Other polyamide polymers which may be advantageously used are nylon 12, nylon 4,6, nylon 6,10, nylon 6,12, nylon 12,12, and their copolymers and mixtures. Illustrative of polyamides and copolyamides which can be employed in the process of this invention are those described in U.S. Pat. Nos. 5,077,124, 5,106,946, and 5,139,729 (each to Cofer et al.) and the polyamide polymer mixtures disclosed by Gutmann in Chemical Fibers International, pages 418-420, Volume 46, December 1996. These publications are all incorporated herein by reference.

The filaments herein can include one or more polyamidation catalysts. Polyamidation catalysts suitable for use in a solid phase polymerization (SPP) process and/or a (re)melt phase polymerization (MPP) process which can be performed in making the filaments herein are oxygen-containing phosphorus compounds including those described in Curatolo et al., U.S. Pat. No. 4,568,736 such as phosphorous acid; phosphonic acid; alkyl and aryl substituted phosphonic acids; hypophosphorous acid; alkyl, aryl and alkyl/aryl substituted phosphinic acids; phosphoric acid; as well as the alkyl, aryl and alkyl/aryl esters, metal salts, ammonium salts and ammonium alkyl salts of these various phosphorus containing acids. Examples of suitable catalysts include X(CH₂)ₙPO₃R₂, wherein X is selected from 2-pyridyl, —NH₂, NHR′, and N(R′)₂, n=2 to 5, R′ and R′ independently are H or alkyl; 2-aminoethylphosphonic acid, potassium tolylphosphinate, or phenylphosphinic acid. Preferred catalysts include 2-(2′-pyridyl)ethyl phosphonic acid, and metal hypophosphite salts including sodium and manganous hypophosphite. It may be advantageous to add a base such as an alkali metal bicarbonate with the catalyst to minimize thermal degradation, as described in Buzinkai et al., U.S. Pat. No. 5,116,919.

An effective amount of the catalyst(s) will generally be dispersed in the polyamide material. Generally the catalyst is added, and therefore present, in an amount from about 0.2 moles up to about 5 moles per million grams, mpmg, of polyamide (typically about 5 ppm to 155 ppm based on the polyamide). Preferably, the catalyst is added in an amount of about 0.4 moles to about 0.8 moles million grams, mpmg, of polyamide (about 10 ppm to 20 ppm based on the polyamide). This range provides commercially useful rates of solid phase polymerization and/or remelt phase polymerization under the conditions of the current invention, while minimizing deleterious effects which can occur when catalyst is used at higher levels, for example pack pressure rise during subsequent spinning.

For effective solid phase polymerization, it is necessary for the amidation catalyst to be dispersed in the polyamide precursor flake. A particularly convenient method for adding the polyamidation catalyst is to provide the catalyst in a solution of polymer ingredients in which polymerization is initiated, e.g., by addition to a salt solution such as the hexamethylene-diammonium adipate solution used to make nylon 6,6.

The polyamide material used to make the high RV filaments will also contain a phenolic, e.g., hindered phenolic, antioxidant stabilizer which is added in a particular manner and at a particular point during melt phase polymerization as hereinafter described. The class of useful phenolic antioxidant stabilizers employed in this invention comprises alkyl-substituted and/or aryl-substituted phenols; and mixtures thereof.

Preferred phenolic antioxidant stabilizers are the alkyl-substituted, hindered phenols. Most preferably, the additive is 1,3,5-trimethyl-2,4,6-tris(3,5-tertbutyl-4-hydroxybenzyl)benzene (IRGANOX™ 1330), tetrakis[methylene(3,5-di-tert-butyl-4-hydroxyhydrocinnamate)]methane (IRGANOX™ 1010); (N,N′hexane-1,6-diylbis(3-(3,5-di-tert-butyl-4-hydroxyphenylpropionamide) (IRGANOX™ 1098) or 3,5-bis(1,1-dimthylethyl)-4-hydroxy-2,2-bis{[3-(3,5-bis(1,1-dimethylethyl)-4-hydroxyphenyl]-1-oxopropoxy}-1,3-propanediyl ester (ANOX® 20).

The antioxidant stabilizer will generally be added in liquid form to the polyamide material in the extruder to form a molten polymer which contains about 0.05 wt % to about 2 wt % of the stabilizer. More preferably, the molten polymer will comprise from about 0.1 wt % to about 0.7 wt % of the antioxidant stabilizer. The filaments produced herein can also optionally contain usual minor amounts of other additives, such as plasticizers, delustrants, pigments, dyes, light stabilizers, heat stabilizers, antistatic agents for reducing static, additives for modifying dye ability, agents for modifying surface tension, etc.

The polyamide filaments herein will have a formic acid RV of greater than about 190. More preferably, the filaments herein will have a formic acid RV of greater than about 200. Most preferably, the filaments herein can have a formic acid RV of from about 202 to about 230.

The formic acid RV of polyamides as used herein refers to the ratio of solution and solvent viscosities measured in a capillary viscometer at 25° C. The solvent is formic acid containing 10% by weight of water. The solution is 8.4% by weight polyamide polymer dissolved in the solvent. This test is based on ASTM Standard Test Method D 789. Preferably, the formic acid RVs are determined on spun filaments, prior to drawing and can be referred to as spun fiber formic acid RVs. The RV of polyamide filaments can decrease from about 3% to about 7% upon drawing at the draw ratios described herein, but the RV of the drawn filaments will be substantially the same as the spun fiber RVs. The formic acid RV determination of a spun filament is more precise than the formic acid RV determination of a drawn filament. As such, for purposes herein, the spun fiber RVs are reported and are considered to be a reasonable estimate of the drawn fiber RVs. The RV of the filaments achievable with this invention exceeds what has been reported for prior art filament preparation processes.

The filaments when drawn will generally have a denier per filament (dpf) of about 2 to about 100 (a dtex per filament of about 2.2 to 111). More preferably, the filaments herein when drawn will have a denier per filament (dpf) of about 10 to 40 (a dtex per filament of about 11.1 to about 44.4). These deniers are preferably measured deniers based on ASTM Standard Test Method D 1577.

The filaments, when drawn, will generally have a tenacity of about 4.0 grams/denier to about 7.0 grams/denier (about 3.5 cN/dtex to about 6.2 cN/dtex). Preferably, the filaments will have a tenacity of about 4.5 grams/denier to about 6.5 grams/denier (about 4.0 cN/dtex to about 5.7 cN/dtex). Further, preferably the percent retained tenacity of the filaments (i) is greater than or equal to about 50% when immersed for 72 hours at 80° C. in an aqueous solution of 1000 ppm of NaOCl, or (ii) is greater than or equal to about 75% when heated at 130° C. for 72 hours. It is more preferred that the filaments have a percent retained tenacity which is greater than about 60% when immersed for 72 hours at 80° C. in an aqueous solution of 1000 ppm of NaOCl.

For purposes herein, the term “filament” is defined as a relatively flexible, macroscopically homogeneous body having a high ratio of length to width across its cross-sectional area perpendicular to its length. The filament cross section can be any shape, but is typically circular. Herein, the term “fiber” is used interchangeably with the term “filament”.

The filaments herein can be any length. The filaments can be cut into staple fibers having a length of about 1.5 to about 5 inches (about 3.8 cm to about 12.7 cm). Furthermore, the staple fiber can be straight (i.e., non crimped) or crimped to have a saw tooth shaped crimp along their length, with a crimp (or repeating bend) frequency of about 3.5 to about 18 crimps per inch (about 1.4 to about 7.1 crimps per cm).

### Apparatus and Process for SPP of Precursor Polymer Flake

In the initial stages of the preferred filament preparation process herein, precursor polyamide flakes are subjected to an SPP process for solid phase polymerization of such precursor flake material. This precursor flake material is made of the polyamide polymer which is ultimately suitable for use in making the filaments of the present invention.

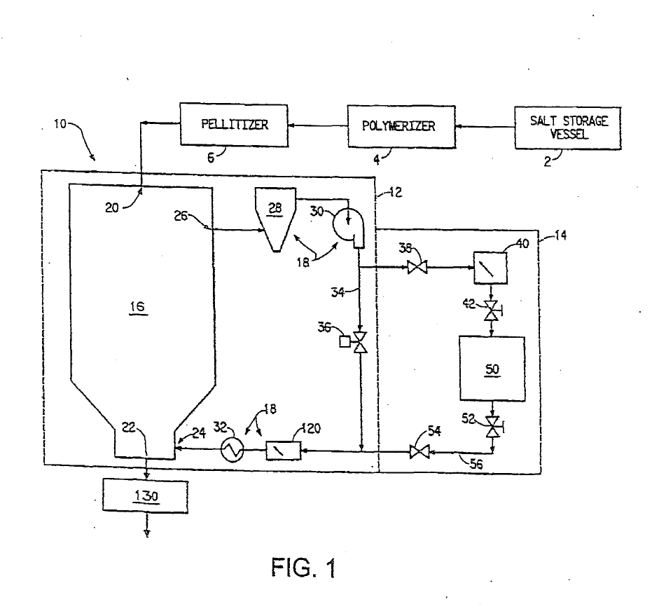

The precursor polymer flake can be prepared using batch or continuous polymerization methods known in the art, pelletized, and then fed to the SPP apparatus. As illustrated in FIG. 1, a typical example is to store a polyamide salt mixture/solution in a salt storage vessel 2. The salt mixture/solution is fed from the storage vessel 2 to a polymerizer 4, such as a continuous polymerizer or a batch autoclave. The previously mentioned polyamidation catalysts can be added simultaneously with the salt mixture/solution or separately. In the polymerizer 4, the polyamide salt mixture/solution is heated under pressure in a substantially oxygen free inert atmosphere as is known in the art. The polyamide salt mixture/solution is polymerized into molten polymer which is extruded from the polymerizer 4, for example, in the form of a strand. The extruded polymer strand is cooled into a solid polymer strand and fed to a pelletizer 6 which cuts, casts or granulates the polymer into flake.

Other terms which can be used to refer to this “flake” material include pellets and granulates. Most conventional shapes and sizes of flake are suitable for use in the present invention. One typical shape and size comprises a pillow shape having dimensions of approximately ⅜ inch (9.5 mm) by ⅜ inch (9.5 mm) by 0.1 inch (0.25 mm). Alternatively, flake in the shape of right cylinders having dimensions of approximately 90 mils by 90 mils (2.3 mm by 2.3 mm) are convenient. Thus, it should be appreciated that the precursor polyamide material can be shaped and fed into the SPP apparatus 10 in other particulate forms than “flake”, and all such particulate forms are amenable to the initial SPP step of the filament preparation process of the instant invention.

The precursor polymer flake has one or more of the polyamidation catalysts hereinbefore described dispersed within the flake. The precursor flake has a formic acid RV of about 40 to about 60. More preferably, precursor flake will have a formic acid RV of about 45 to 55. Most preferably, the precursor flake will have a formic acid RV of about 45 to 50. Further, the precursor flake can contain variable amounts of absorbed water.

Suitable SPP apparatus 10 comprises a SPP assembly 12 and a serially connected dual desiccant bed regenerative drying system 14. The SPP assembly 12 has a SPP vessel 16 and a gas system 18.

The SPP vessel 16, otherwise known in the art as a flake conditioner, has a flake inlet 20 for receiving the precursor flake, a flake outlet 22 for removing the flake after being solid phase polymerized in the SPP vessel 16, a gas inlet 24 for receiving circulating gas, and a gas outlet 26 for discharging the gas. The flake inlet 20 is at the top of the SPP vessel 16. The flake outlet 22 is at the bottom of the SPP vessel 16. The gas inlet 24 is towards the bottom of the SPP vessel 16, whereas the gas outlet 26 is towards the top of the SPP vessel 16. The flake can be fed one batch at a time or continuously into the flake inlet 20 of the SPP apparatus 10. The flake can be fed into the SPP apparatus 10 at room temperature or preheated. In a preferred embodiment, the SPP vessel 16 can contain up to about 15,000 pounds (6,800 kilograms) of the flake.

The gas system 18 is for circulating substantially oxygen free inert gas, such as nitrogen, argon, or helium, into the gas inlet 24, through interstices between, thereby contacting, the flake in the SPP vessel 16, and then out the gas outlet 26. Thus, the gas circulates upwardly through the SPP vessel 16 counter current to the direction of flake flow when the process continually feeds flake into the flake inlet 20 and removes flake from the flake outlet 22 of the SPP vessel 16. The preferred gas is nitrogen. Atmospheres containing other gases, for example nitrogen containing low levels of carbon dioxide, can also be used. For purposes of the present invention, the term “substantially oxygen free” gas refers to a gas containing at most about 5000 ppm oxygen when intended for use at temperatures of the order of 120° C. down to containing at most about 500 ppm oxygen for applications approaching 200° C. and containing as low as a few hundred ppm oxygen for some applications highly sensitive to oxidation.

The gas system 18 has a filter 28 for separating and removing dust and/or polymer fines from the gas, a gas blower 30 for circulating the gas, a heater 32 for heating the gas, and a first conduit 34 connecting, in series and in turn, the gas outlet 26, the filter 28, the blower 30, the heater 32, and the gas inlet 24.

The filter 28 removes fine dust generally comprising volatile oligomers which have been removed from the flake and subsequently precipitated out as the gas has cooled. A suitable filter 28 is a particulate cyclone separator that impinges circulating gas on a plate causing solids to drop out, such as described on Pages 20-81 through 20-87 of the Chemical Engineers' Handbook, Fifth Edition, by Robert H. Perry and Cecil H. Chilton, McGraw-Hill Book Company, NY, N.Y., published 1973. Alternatively, filters of nominally 40 microns or less are sufficient to remove the fine powder that can be created in the process. It is preferred to remove the volatile oligomers before the gas passes through desiccant beds of the drying system 14 as they can be a fire hazard during regeneration of the desiccant.

Preferably, the blower 30 is adapted to force a substantially constant amount of the gas per unit time through the SSP vessel 16 while maintaining pressure of the gas in the drying system 14 at about 2 psig to about 10 psig (about 14 kilopascals to about 70 kilopascals) and to maintain gas flow and positive pressure in the SPP vessel 16. The blower 30 can heat the circulating gas up several degrees Celsius or more depending on the make and model of the blower 30 that is used. In a preferred embodiment, the blower 30 is adapted to circulate gas through the SPP vessel 16 at a rate of about 800 to about 1800 standard cubic feet per minute (about 29 cubic meters per minute to about 51 cubic meters per minute). Gas flow is maintained low enough to preclude fluidization of the flake.

The heater 32 is adapted to heat the gas in the SPP vessel 16 to a temperature of about 120° C. to about 200° C., preferably, about 150° C. to about 190° C., and most preferably to about 170° C. to about 190° C. The gas is generally heated to provide the thermal energy to heat the flake. At the gas inlet 24, temperatures below about 150° C., require the flake residence time in the SPP vessel 16 to be too long and/or require the use of undesirably large solid phase polymerization vessels. Gas inlet temperatures greater than 200° C. can result in thermal degradation and agglomeration of the flake. The temperature of the gas existing the SPP vessel 16 through the gas outlet 26 can be at or below 100° C. requiring reheating by the heater 32 before reentry to the SPP vessel 16.

The serially connected dual desiccant bed regenerative drying system 14 is connected in parallel with the first conduit 34 between the blower 30 and the gas inlet 24. The drying system 14 is for drying the circulating gas increasing the removal of water from the flake in the SPP vessel 16. Water removal in turn drives the condensation reaction of the polyamide flake towards higher RV. Thus, the drying system 14 is for drying and lowering the dew point temperature of at least a portion of the circulating gas such that the dew point temperature of the gas at the gas inlet 24 is no more than about 20° C. More preferred, the dew point temperature of the gas at the gas inlet 24 is about −10° C. to 20° C. Most preferred, the dew point temperature of the gas at the gas inlet 24 is about 0° C. to about 10° C. The dew point temperature of the gas exiting the SPP vessel 16 through the gas outlet 26 can be above 30° C. and in need of drying.

The portion of the gas that is passed through the drying system 14 can be up to 100% of the total gas stream circulated through the SPP vessel 16. However, if less than 100% of the total gas stream is bypassed through the drying system 14, then the dew point temperature at the gas inlet 24 can be controlled more accurately with a lower capacity, and therefore less expensive, drying system. Further, adjusting the portion of the gas being dried provides a fine quantity control for selecting and controlling the RV of the flake removed from the SPP vessel 16. Such adjustments provide useful means for producing uniform RV flake. Thus, it is more preferred that the portion of the gas that is passed through the drying system 14 is about 10% to about 50% of the total gas stream circulated through the SPP vessel 16. Most preferred, the portion of the gas that is passed through the drying system 14 is about 20% to about 40% of the total gas stream circulated through the SPP vessel 16.

Preferably, the drying system 14 is connected in parallel with the first conduit 34 and between the blower 30 and the heater 32. There can be an adjustable valve 36 connected in the first conduit 34 between the blower 30 and the heater 32. Then the drying system 14 can be connected in parallel with the adjustable valve 36.

The drying system 14 comprises an optional first valve 38, an optional gas flow meter 40, an optional second valve 42, a serially connected dual desiccant bed regenerative dryer 50, an optional third valve 52, an optional fourth valve 54, and a second conduit 56 interconnecting, in turn, the first conduit 34 (preferably between the blower 30 and the adjustable valve 36), the optional first valve 38, the optional gas flow meter 40, the optional second valve 42, the serially connected dual desiccant bed regenerative dryer 50, the optional third valve 52, the optional fourth valve 54, and the first conduit 34 (preferably between the adjustable valve 36 and the heater 32). The first and fourth valves 38,54 are useful if one wants to take the drying system 14 off line for maintenance work. As such, the first and fourth valves 38,54 can be, for instance, manual butterfly valves that are designed to be used in either a fully open or fully closed position. The second and third valves 42,52 are useful if one wants to isolate the dryer 50 from the remainder of the drying system 14 for maintenance or replacement of the dryer 50. The second and third valves 42,52 can be, for instance, manual isolation valves.

Referring further to FIG. 1, the SPP apparatus 10 can optionally include a dew point temperature measurement instrument 120 connected to the first conduit 34 for measuring the dew point temperature of the combined gas stream in the first conduit 34 downstream of the drying system 14. The dew point temperature measurement instrument 120 can be connected to the first conduit 34 downstream of the drying system 14, either before (as depicted in FIG. 1) or after the heater 120. In either case, the dew point temperature measurement instrument 120 should be positioned close enough to the gas inlet 24 to provide a measurement of the temperature at the gas inlet 24.

The SPP apparatus 10 is adapted such that solid state polymerization of the flake occurs in the SPP vessel 16 increasing the formic acid RV of the flake while the gas is filtered, dried, heated and circulated through the interstices between, thereby contacting, the flake in the SPP vessel 16 at a temperature of about 120° C. to about 200° C. for about 4 hours to about 24 hours, after which flake having a formic acid RV of at least about 90 can be removed from the flake outlet 22. More preferably, the flake residence time in the SPP vessel 16 is about 5 hours to about 15 hours, most preferably about 7 hours to about 12 hours. Preferably, continuous drying of the flake in the SPP vessel 16 proceeds throughout the residence time. More preferably, the flake removed from the flake outlet 22 has a formic acid RV of about 90 to 120, most preferably, of about 100 to 120.

In summary, the SPP phase of a preferred process herein can comprise the following steps. First, the precursor flake is fed into the SPP vessel 16. Second, dust and/or polymer fines are preferably separated and removed from the gas by the filter 28. Third, at least a portion of the gas is dried with the serially connected dual desiccant bed regenerative drying system 14 such that the gas entering the SPP vessel 16 has a dew point temperature of no more than 20° C. Fourth, the gas is heated by the heater 32 to a temperature of about 120° C. to about 200° C. Fifth, the filtered, dried, heated gas is circulated by the blower 30 through interstices between the flake in the SPP vessel 16 for about 4 to about 24 hours. Sixth, the flake having a formic acid RV of at least about 90 is removed from the flake outlet 22 of the SPP vessel 16.

The flake having a formic acid RV of at least about 90 can be withdrawn from the flake outlet 22 at the same rate that flake is fed into the flake inlet 20 to maintain the flake volume in the SPP vessel 16 substantially the same.

### Process for MPP of Molten Polymer

The filament preparation process herein includes MPP procedures for melt phase polymerizing molten polyamide polymer which is then formed into filaments. The MPP and melt-spinning phases of the process herein comprise the following steps:

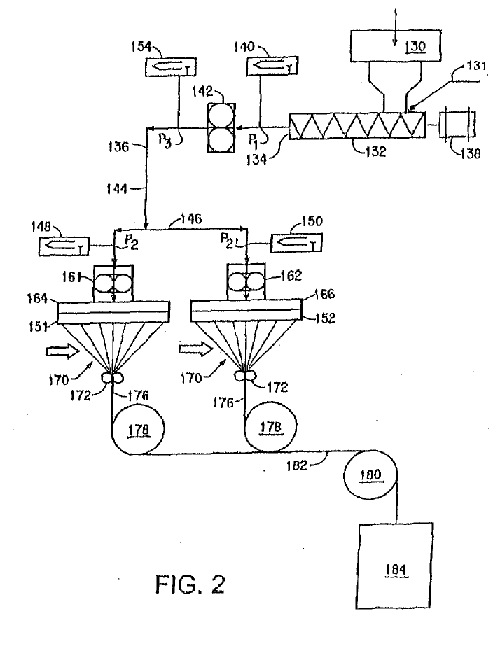

As shown in FIGS. 1 and 2, the SPP apparatus 10 can be coupled to a flake feeder 130 which, in turn, is coupled to feed the polymer flake at a temperature of about 120° C. to about 200° C. into a non-vented melt-extruder 132. The flake feeder 130 can be, for instance, a gravimetric or volumetric feeder. In a preferred embodiment, the feeder 130 can provide a metered amount of the flake to the melt-extruder 132 in the range of about 1100 pounds per hour to about 1900 pounds per hour (500 kilograms per hour to about 862 kilograms per hour), more preferably of about 1180 pounds per hour to about 1900 pounds per hour (536 kilograms per hour to about 818 kilograms per hour).

The polyamide flake that is fed into the melt-extruder 132 comprises a formic acid RV of about 90 to 120, and a polyamidation catalyst dispersed within the flake. Preferably, the flake has a formic acid RV of about 100 to 120. The flake fed to the melt-extruder will also generally have a moisture content of less than about 0.04 wt %, more preferably from about 0.01 wt % to 0.03 wt %. Flake removed from the SPP assembly 10 is quite suitable for feeding into the melt-extruder 132.

The melt-extruder 132 can be a single screw melt-extruder, but preferably a double screw melt-extruder is used. A suitable double screw melt-extruder is included in melt-extruder assembly model number ZSK120 is commercially available from Krupp, Werner & Pfliederer Corporation at Ramsey, N.J.

In accordance with the process of the present invention, a phenolic antioxidant stabilizer of the type described hereinbefore is introduced, e.g., injected, into the melt-extruder 132 through line 131 at or near the flake feed end of the extruder. It has been found that when such a phenolic antioxidant stabilizer material is introduced into the extruder in liquid form, without being premixed with polyamide material, the process herein is especially suitable for preparing polyamide filaments of very high RV values.

The liquid antioxidant stabilizer will generally be injected into the melt-extruder 132 in amounts and at rates suitable to provide a concentration of antioxidant stabilizer in the molten polymer exiting the extruder of from about 0.2 wt % to 2.0 wt %, more preferably from about 0.5 wt % to 1.5 wt %. Water can be also be added in the melt-extruder 132 for more precise RV control in the ultimately resulting filaments.

The flake is melted in the melt-extruder 132 and molten polymer is extruded from an outlet 134 of the melt-extruder 132 to a transfer line 136. A motor assembly 138 rotates one or more screw device(s) in the melt-extruder 132 increasing the temperature of the polymer due to the mechanical work of the screw(s). As is known in the art, associated apparatus including insulation and/or heating or cooling elements maintain controlled temperature zones along the melt-extruder 132 allowing sufficient heat to melt, but not overheat, the polymer. This associated apparatus is part of the melt-extruder assembly mentioned above which is commercially available from Coperion Corporation of Ramsey, N.J.

The polymer undergoes melt phase polymerization in the melt-extruder 132 and in the transfer line 136 increasing the temperature of the polymer. As such, the temperature of the molten polymer in the transfer line 136 at point P1 within about 5 feet (2.4 m) of the outlet 134 of the melt-extruder 132 ranges from about 285° C. to about 295° C., preferably about 289° C. to about 291° C. A temperature sensor 140 can be connected to the transfer line 136 at point P1 to measure this temperature.

The extruded molten polymer is conveyed by a booster pump 142, through the transfer line 136 to at least a spinneret 151,152 of at least a spinning machine. The transfer line 136 includes a conduit 144 and a manifold 146. The conduit 136 connects the melt-extruder 132 to the manifold 146. The manifold 146 connects to each of the spinnerets 151,152. The temperature in the transfer line 136 (or, more specifically, the manifold 146 of the transfer line 136) at points P2,P2′ within 5 feet (2.4 m) of the spinnerets 151,152 is about 295° C. to about 300° C., preferably, of about 296° C. to about 298° C. Additional temperature sensors 148,150 can be connected to the manifold 146 at points P2 and P2′ to measure the temperatures at these points. An additional temperature sensor 154 can be connected to the transfer line 136 at point P3 between the booster pump 142 and the manifold 146 to obtain an additional temperature measurement. Preferably the temperature at this point (booster pump discharge temperature) can range from about 290° C. to 300° C. The residence time of the molten polymer in the melt-extruder 132 and the transfer line 136 is about 3 to about 15 minutes, and preferably about 3 to about 10 minutes.

It has been found that filaments of especially high RV can be spun if an appropriate balance is maintained between the pressure drop within the system conveying molten polymer from the extruder to the manifold and the amount of throughput of molten polymer being conveyed. In particular, in accordance with this invention, the ratio of the pressure drop (ΔP in psig) between the booster pump 142 and the manifold 146 to molten polymer throughput (in kg/hr) should be maintained within the range of from about 2.5 to 3.5, more preferably form about 2.8 to 3.2. (For purposes of this invention, pressure and throughput values are determined using transfer lines having an average of 2.83 inch (7.2 cm) inside diameter, with a total length of the distance between booster pump pressure bulb and the manifold pressure bulb being 38.3 feet (11.68 meters).

Metering pumps 161,162 force the molten polymer from the manifold 146 through spin filter packs 164,166 and then the spinnerets 151,152, each having a plurality of capillaries through the spinneret 151,152 thereby spinning the molten polymer through the capillaries into a plurality of filaments 170 having a spun fiber formic acid RV of greater than about 190, preferably of about 200 to about 250, and most preferably, of about 205 to about 230.

Preferably, the molten polymer is spun through a plurality of the spinnerets 151,152, each spinneret 151,152 forming a plurality of the filaments 170. The filaments 170 from each spinneret 151,152 are quenched typically by an air flow (illustrated in FIG. 2 by arrows) transverse to the length of the filaments 170, converged by a convergence device 172, coated with a lubricating spin finish, into a continuous filament tow 176. The tows 176 are directed by feed rolls 178 and optionally one or more change of direction roll 180. The tows 176 can be converged together forming a larger continuous filament combined tow 182 which can be fed into a storage container 184, called a “can” by those skilled in the art.

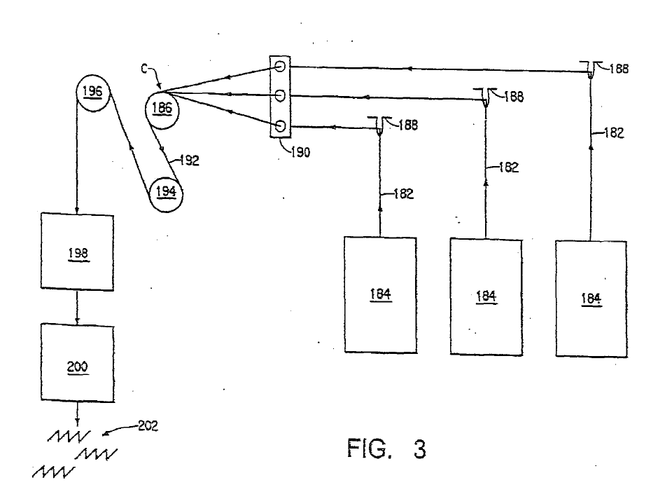

Referring to FIG. 3 the tows 182 can be removed by a feed roll 186 from several of the cans 184. The tows 182 can be directed by devices, such as wire loops 188 and/or a ladder guide 190 which is typically used to keep tows 182 spaced apart until desired. The tows 182 can be combined, such as at point C in FIG. 3, into a continuous filament tow band 192. Then the continuous filament tow band 192 can be drawn by contact with a draw roll 194 which rotates faster than the feed roll 186. The continuous filament tow band 192 can be drawn 2.5 to 4.0 times, according to known processes, to provide a drawn denier per filament (dpf) in a range of about 2 to about 100 (about 2.2 dtex/f to about 111.1 dtex/f). The continuous filament tow band 192 can typically have 20 to 200 thousand continuous filaments. If space requires, one or more change of direction roll(s) 196 can redirect the tow band 192. Then the continuous filament tow band 192 can be crimped by a crimping apparatus 198, such as by forcing the continuous filament tow band 192 into a stuffing box. Then the crimped drawn continuous filament tow band can be cut by a cutter 200 providing the staple fibers 202 of the present invention described above.

### Test Methods

The following test methods can be used in the following Examples and in connection with characterization of the present invention.

Relative viscosity (RV) of nylons refers to the ratio of solution or solvent viscosities measured in a capillary viscometer at 25° C. (ASTM D 789). The solvent is formic acid containing 10% by weight water. The solution is 8.4% by weight polymer dissolved in the solvent.

Denier (ASTM D 1577) is the linear density of a fiber as expressed as weight in grams of 9000 meters of fiber. The denier is measured on a Vibroscope from Textechno of Munich, Germany. Denier times (10/9) is equal to decitex (dtex).

Tenacity (ASTM D 3822) is the maximum or breaking stress of a fiber as expressed as force per unit cross-sectional area. The tenacity is measured on an Instron model 1130 available from Instron of Canton, Mass. and is reported as grams per denier (grams per dtex).

Denier and tenacity tests performed on samples of staple fibers are at standard temperature and relative humidity conditions prescribed by ASTM methodology. Specifically, standard conditions mean a temperature of 70+/−2° F. (21+/−1° C.) and relative humidity of 65%+/−2%.

### EXAMPLES

The invention herein can be illustrated by the following specific examples. All parts and percentages are by weight unless otherwise indicated. Examples prepared according to the process of the current invention are indicated by numerical values. Control or Comparative Examples are indicated by letters.

In the examples herein, various staple fibers were produced having various spun fiber formic acid RV values. The procedures used involved an SPP phase, an MPP phase and a staple fiber production phase.

In all instances, precursor polymer flake was fed to a SPP vessel 16 of a SPP apparatus like the one illustrated in FIG. 1. The precursor flake polymer was homopolymer nylon 6,6 (polyhexamethylene adipamide) containing a polyamidation catalyst (i.e., manganous hypophosphite obtained from Occidental Chemical Company with offices in Niagara Falls, N.Y.) in concentration by weight of 16 parts per million The precursor flake which was fed into the SPP vessel 16 had a formic acid RV of 48.

A serially connected dual desiccant bed regenerative drying system 14 was connected in parallel with an adjustable solenoid activated valve 36 between the blower 30 and the dew point measurement instrument 120 of the gas system. The dryer 50 was a Sahara Dryer, model number SP-1800 commercially available from Henderson Engineering Company of Sandwich, Ill. The gas circulated through the gas system 12 was nitrogen. The regenerative dual desiccant bed circulating gas drying system 14 was used to increase the RV of the polymer flake. The pressure of the gas in the drying system 14 was about 5 psig (35 kPa). The dew point temperature of the gas exiting the dryer system 14 was measured by instrument 120.

Higher RV flake was removed from a flake outlet 22 of the SPP vessel 16 as shown in FIG. 1 and was then fed to a melt-phase polymerization (MPP) system similar to the setup shown in FIG. 2. In the MPP system, a non-vented twin screw melt-extruder 132 melted and extruded the flake into molten polymer and into a transfer line 136. A liquid hindered phenolic stabilizer (i.e., ANOX® 20, obtained from Chemtura Corporation) was injected into the front end of melt-extruder 132 through line 131. Stabilizer was injected into the extruder so as to provide a stabilizer concentration of 0.3% by weight concentration in the molten polymer exiting the extruder.

This molten polymer was pumped by booster pump 142 via transfer line 136 to a manifold 146 and metered to a plurality of spinnerets 151,152 and then spun into filaments 170. The residence time of the polymer in the melt-extruder 132 and transfer line 136 was about 5 minutes. The filaments were converged into a continuous filament tows 176.

As shown in FIG. 3, a plurality of the continuous filament tows were converged into a continuous filament tow band 192 and then drawn. The drawn band 192 was crimped and cut into staple fibers 202. The staple fibers 202 produced were approximately 15 denier (16.7 decitex) per filament.

Process conditions and fiber RV values for the several fibers of Examples 1-5 and comparative Examples A-D are shown in Table 1.

TABLE 1

| | | | SPP | | | | | | | | |
|---|---|---|---|---|---|---|---|---|---|---|---|
| | T′put | SPP | Gas | B Pump | Manif | B Pump | Manif | Spin | Delta | | |
| Exple | Kg/hr | Gas | Temp | Temp | Temp | Press | Press | Press | Press | ΔP/T′put | |
| No. | cfm | Flow | ° C. | ° C. | ° C. | PSIG | PSIG | PSIG | PSIG | PSIG/Kg/hr | RV |
| 1 | 540 | 1284 | 185 | 291 | 296 | 4000 | 2246 | 1049 | 1754 | 3.25 | 229 |
| 2 | 540 | 1220 | 185 | 295 | 298 | 4000 | 2161 | 991 | 1839 | 3.41 | 204 |
| 3 | 540 | 1211 | 185 | 295 | 298 | 3997 | 2285 | 1008 | 1712 | 3.17 | 215 |
| 4 | 540 | 1242 | 185 | 296 | 298 | 4000 | 2272 | 1005 | 1728 | 3.20 | 202 |
| 5 | 540 | 1170 | 184 | 296 | 298 | 3875 | 2265 | 967 | 1610 | 2.98 | 204 |
| 6 | 455 | 997 | 195 | 287 | 296 | 3950 | 2241 | — | 1709 | 3.76 | 234 |
| 7 | 540 | 1022 | 193 | 288 | 296 | 3925 | 2220 | — | 1705 | 3.16 | 221 |
| A | 860 | 1320 | 190 | 286 | 298 | 3656 | 2476 | 1124 | 1180 | 1.37 | 173 |
| B | 860 | 1318 | 190 | 284 | 298 | 3823 | 2324 | 1397 | 1499 | 1.74 | 167 |
| C | 860 | 1312 | 190 | 289 | 298 | 3902 | 2374 | 1374 | 1528 | 1.78 | 172 |
| D | 860 | 1324 | 190 | 288 | 298 | 3950 | 2544 | 1181 | 1406 | 1.63 | 161 |

What is claimed:

1. A process for preparing a plurality of meltspun polyamide filaments having a denier of from about 2 to about 100, a formic acid relative viscosity (RV) of greater than about 190, and tenacity and tenacity retention characteristics which render such filaments especially suitable for use in papermaking machine felts, said process comprising:
A) feeding solid phase polymerized polyamide flakes having a formic acid relative viscosity (RV) of from about 90 to 120 and a moisture content of less than about 0.04 wt % into a non-vented melt-extruder at a temperature of from about 120° C. to 200° C.;
B) melting the flakes in the melt-extruder while introducing at a flake feed end of said extruder a liquid phenolic antioxidant stabilizer which has not been premixed with polyamide material;
C) extruding molten polymer resulting from the melting of said flakes from an outlet end of said melt-extruder to a transfer line wherein the temperature of the molten polymer in the transfer line within 5 feet (2.4 m) of the outlet end of the melt-extruder is from about 285° C. to 295° C.;
D) conveying the molten polymer through said transfer line via a booster pump and a manifold to at least one spinneret of at least one spinning machine such that the temperature in the transfer line within 5 feet (2.4 m) of the at least one spinneret is from about 295° C. to 300° C., and such that the ratio of the pressure drop (ΔP in psig) between said booster pump and said manifold to molten polymer throughput (in kg/hr) ranges from about 2.5 to 3.5; and
E) spinning the molten polymer through the at least one spinneret to form a plurality of said meltspun polyamide filaments.

2. A process according to claim 1 wherein the solid phase polymerized polyamide flakes which are fed to said extruder comprise a synthetic melt spinnable polyamide polymer and a polyamidation catalyst dispersed within the flakes, and
wherein said solid phase polymerized polyamide flakes have been prepared by the steps of:
i) feeding precursor polyamide flakes with polyamidation catalyst dispersed therein and having a formic acid relative viscosity of from about 40 to 60 into a solid phase polymerization vessel;
ii) contacting said precursor flakes within said vessel with a substantially oxygen free inert gas;
iii) drying at least a portion of said gas with a serially connected dual desiccant bed regenerative drying system such that the gas entering said vessel has a dew point of no more than about 10° C.;
iv) heating the gas to a temperature of from about 120° C. to 200° C.;
v) circulating the filtered, dried, heated gas through interstices between the flakes in said vessel for 4 to 24 hours; and
vi) removing from the vessel, and feeding to said melt-extruder, flakes having a formic acid relative viscosity of from about 90 to 120.

3. A process according to claim 2 wherein the rate of flow of substantially oxygen free inert gas throughout said solid phase polymerization vessel ranges from about 1000 to 1800 cubic feet per minute.

4. A process according to claim 2 wherein said substantially oxygen-free inert gas entering said solid phase polymerization vessel has a temperature of from about 150° C. to 190° C. and a dew point of from about −10° C. to 20° C.

5. A process according to claim 2 wherein the polyamidation catalyst dispersed within said polyamide flakes is selected from the group consisting of phosphorous acid; phosphonic acid; alkyl and aryl substituted phosphonic acids; hypophosphorous acid; alkyl, aryl and alkyl/aryl substituted phosphinic acids; phosphoric acid; and the alkyl, aryl and alkyl/aryl esters, metal salts, ammonium salts and ammonium alkyl salts of these phosphorus-containing acids.

6. A process according to claim 5 wherein the temperature of said molten polymer at its discharge from the booster pump ranges from about 290° C. to 300° C., and wherein the temperature of said molten polymer within said manifold ranges from about 296° C. to 298° C.

7. A process according to claim 6 wherein the requisite temperatures of said molten polymer are maintained by cooling means associated with said melt-extruder at or near its outlet end and/or by adjusting molten polymer throughput by alteration of the diameter of said transfer line or by alteration of the pressure drop across said melt-extruder and/or said booster pump.

8. A process according to claim 1 wherein said liquid antioxidant stabilizer is selected from the group consisting of alkyl-substituted and/or aryl-substituted phenols and mixtures thereof.

9. A process according to claim 8 wherein said antioxidant stabilizer is selected from the group consisting of 1,3,5-trimethyl-2,4,6-tris(3,5-tertbutyl-4-hydroxybenzyl)benzene (IRGANOX™ 1330), tetrakis[methylene(3,5-di-tert-butyl-4-hydroxyhydrocinnamate)]methane (IRGANOX™ 1010); (N,N′hexane-1,6-diylbis(3-(3,5-di-tert-butyl-4 hydroxyphenylpropionamide) (IRGANOX™ 1098) or 3,5-bis(1,1-dimthylethyl)-4-hydroxy-2,2-bis{[3-(3,5-bis(1,1-dimethylethyl)-4-hydroxyphenyl]-1-oxopropoxy}-1,3-propanediyl ester (ANOX® 20).

10. A process according to claim 9 wherein said antioxidant stabilizer is injected into said melt-extruder in amounts and at rates which provide a concentration of antioxidant stabilizer in said molten polymer exiting the melt-extruder of from about 0.2 wt % to 2.0 wt %.

11. A process according to claim 1 wherein said meltspun polyamide filaments have a formic acid relative viscosity of greater than about 200.

12. A process according to claim 11 wherein filaments produced by the process have a tenacity of from about 4.0 grams/denier to about 7.0 grams/denier (from about 3.5 cN/dtex to about 6.2 cN/dtex).

13. A process according to claim 11 wherein filaments produced by the process have a tenacity of from about 4.5 grams/denier to about 6.5 grams/denier (from about 4.0 cN/dtex to about 5.7 cN/dtex).

14. A process according to claim 11 wherein said polyamide filaments comprise poly(hexamethylene adipamide) [nylon 6,6], poly(ε-caproamide) [nylon 6], or copolymers or mixtures thereof.

15. A plurality of filaments suitable for use in making fibers for papermaking machine felts each of which filaments comprises a synthetic melt spun polyamide polymer and has
A) a formic acid relative viscosity of greater than about 190;
B) a denier of from about 2 to about 100 (a decitex of about 2.2 to about 111); and
C) a tenacity of from about 4.0 grams/denier to about 7.0 grams/denier (from about 3.5 cN/dtex to about 6.2 cN/dtex).

16. A plurality of filaments according to claim 15 wherein said filaments have a formic acid relative viscosity of greater than about 200.

17. A plurality of filaments according to claim 16 wherein the polyamide polymer used to form said filaments is selected from the group consisting of poly(hexamethylene adipamide) [nylon 6,6], poly(ε-caproamide) [nylon 6] and copolymers or mixtures thereof.

18. A plurality of staple fibers having a length of about 1.5 to about 5 inches (about 3.8 cm to about 12.7 cm) wherein said staple fibers are cut from a plurality of filaments according to claim 16.

19. A plurality of staple fibers according to claim 18 wherein the staple fibers have a saw tooth shaped crimp, with a crimp frequency of about 3.5 to about 18 crimps per inch (about 1.4 to about 7.1 crimps per cm).
